(19) United States
(12) Patent Application Publication
(10) Pub. No.: US 2003/0084348 A1
(43) Pub. Date: May 1, 2003

(54) Firewall computer system

(76) Inventors: Takeshi Miyao, Hitachiota (JP); Yoshimitsu Namioka, Tokai-mura (JP)

Correspondence Address: DICKSTEIN SHAPIRO MORIN & OSHINSKY LLP, 2101 L STREET NW, WASHINGTON, DC, 20037-1526, US

(21) Appl. No.: 10/205,548

(22) Filed: Jul. 26, 2002

Related U.S. Application Data
(63) Continuation of application No. 10/118,255, filed on Apr. 9, 2002.

(30) Foreign Application Priority Data
Nov. 1, 2001 (JP) 2001-336155

(51) Int. Cl. G06F 11/30; G06F 15/173

(52) U.S. Cl. 713/201; 709/223

(57) ABSTRACT

To provide a firewall computer system enabling to execute the firewall and the server on a single computer without sacrificing the security level of the firewall.

The firewall 401 is executed by the first operating system 301 and the server 501 is executed by the second operating system 302, both operating systems are installed in a single computer, and the access control rule storage part 411 is provided in the firewall 401. The access data acquired form the network 601 and directed to the server 501 is judged by the firewall 401 in order to determine whether its data transfer is enabled or disabled, and the access data with its data transfer judged to be enabled is transferred to the server 501.

### BACKGROUND OF THE INVENTION

The present invention relates a firewall computer system for attaining the higher security for the information accessed through the network by means of installing and switching plural operating systems in a single computer.

The technology for access control in the compute system and the network system is generally called firewall and put into practical use. The software for access control is designated a firewall, and the computer in which the firewall operates is designated a firewall computer.

The firewall is interpreted technically as being operated on the operating system of the computer system. The firewall has access control rules and controls the filtering the communication data so as to be enabled or disabled according to those rules. The access control rules are generally known as those for specifying the pass-through enabled or the pass-through disabled of the communication data on the basis of the network address of the destination computer system.

The firewall is a dedicated apparatus exclusive for access control, and is configured so that the firewall computer system may not operate the application server (server) by itself. Thus, the firewall computer is installed independently in addition to the server computer.

For example, in Japanese Patent Laid-Open Number 2000-123097 (2000), what is disclosed is such a configuration as the firewall computer and the server are embedded in the separated apparatus in order to establish a secured transaction through the firewall. In case of operating the firewall with a single computer, though it is allowed to operate the server applications with this computer, the operating system executed in this computer is shared by both of the firewall and the server.

In the prior art, the operating system is shared in a singe computer for operating the fire wall and the server. In case of executing the firewall and the server in a single computer and sharing the operating system, the primary functions of the operating system such as the user management and the communication management are shared by the firewall and the server concurrently.

In this case, there may be such a problem that the user management and the communication management for the firewall are restricted by the server and that the security level may be reduced according to the operation level of the server.

### SUMMARY OF THE INVENTION

An object of the present invention is to provide a firewall computer system enabling to operate the firewall and the server in a single computer without sacrificing the security level of the firewall.

The characteristic of the present invention is addressed as the procedures including installing at least the first and second operating systems in a single computer and switching the first and second operating systems, executing the firewall by the first operating system, executing the server by the second operating system, and providing the control rules with the firewall, making the firewall judge whether the data transfer is enabled or disabled for the access data to be transferred from the network to the server, and allowing the access data judged to be enabled to be transferred to the server.

In the implementation, the access data requested from the network are made interrupted and processed by the firewall, and only the access data judged to be enabled are transferred to the server in response to the judgment of the firewall for enabling or disabling the data transfer.

In this embodiment, as the individual operating systems are installed independently in the firewall and the server and the access data to be transferred to the server is judged by the firewall, it will be appreciated that both of the firewall and the server may be executed in a single computer without sacrificing the security level of the firewall.

### BRIEF DESCRIPTION OF DRAWINGS

FIG. 1 shows a block diagram illustrating one embodiment of the present invention.

FIG. 2 shows a block diagram of the computer hardware illustrating one embodiment of the present invention.

FIG. 3 shows a block diagram showing an example of the firewall.

FIG. 4 shows an example of the data format.

FIG. 5 shows a block diagram illustrating an example of the server.

FIG. 6 shows an example of the access control rule.

FIG. 7 shows a function block diagram showing an example of the control program part.

FIG. 8 shows a flowchart illustrating the operation of the control program part.

FIG. 9 shows a block diagram illustrating another embodiment of the present invention.

FIG. 10 shows a procedural sequence illustrating the operation of another embodiment of the present invention.

### DESCRIPTION OF THE PREFERRED EMBODIMENTS

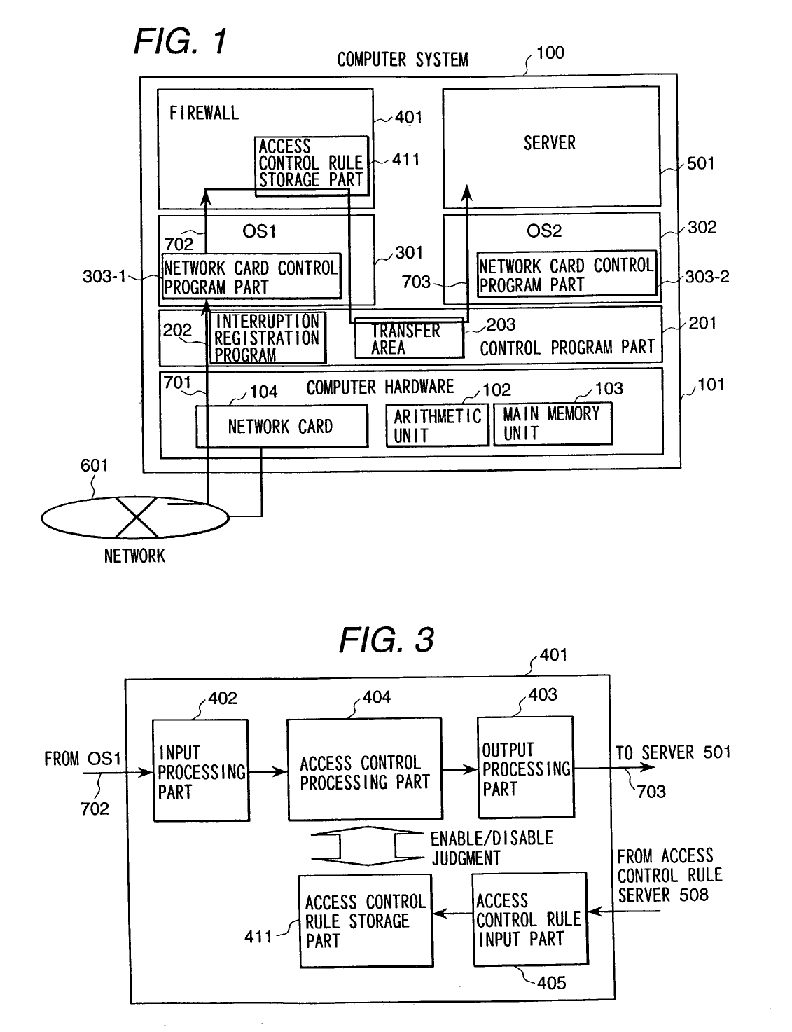

FIG. 1 shows an embodiment of the present invention. FIG. 1 shows an example in which the firewall is executed on the first operating system (hereinafter referred to as OS1) and the server is executed on the second operating system (hereinafter referred to as OS2).

FIG. 1 illustrates the configuration of the computer system, in which the computer hardware 101 comprises the arithmetic unit (processor) 102, the main memory unit (main memory) 103 and the network card (input and output unit) 104.

The network card 104 is connected to the network 601 through which the access data is transmitted. The computer hardware 101 has a control program part 201 having an OS switching function for switching OS1 301 and OS2 302.

The control program part 201 has the interruption registration table 202 storing the mapping of the interruption from the devices such as the network card 104 and other peripheral devices onto the individual interruption handling programs, and the transfer area 203 as the main memory buffer area for data transfer between OS1 301 and OS2 302.

OS1 301 and OS2 302 have the network card control program pars 303-1 and 303-2, respectively. The interruption registration table 202 stores the pointers to the network card control program 303-1 for OS1 301 as the interruption handler.

The procedural operations for the firewall 401 are executed on OS1 301 and the procedural operations for the server 501 are executed on OS2 302. The firewall 401 has the rule storage part 411 for storing the access control rules for judging whether the access data transmitted from the network 601 may be transferred to the server 501.

In the computer system 100, receiving the access data from the network 601, the network card 104 sends the interruption to the control program part 202. The control program part 201 activates the network card control program part 303-1 for OS1 301 according to the interruption registration table 202, and receives the access data from the network 601. The access data is received along the path marked with the thick line 701.

At this point, the network card control program part 303-2 for OS2 302 which is not registered on the interruption registration table 202 is not executed.

The network card control program part 303-1 for OS1 301 transfers the access data received from the network 601 to the fire wall 401 executed on OS1 301 through the path 702 marked with the thick line. The firewall 401 judges whether the access data may be transferred or not by referring to the access data and the access control rules stored in the rule storage part 411.

The firewall 401 judges the path-through enabled or disabled of the access data, and then, in case of the path-through enabled, the firewall transfers the access data through the thick-lined path 703 to the server 501 waiting the data to be received via the transfer area 203 of the control program part 201.

According to the above operations, the access data received by the computer system 100 from the network 601 is judged definitely by the firewall 104 and transferred to the server 501. If the access data is judged to be unauthorized, the firewall 401 can reject the access data.

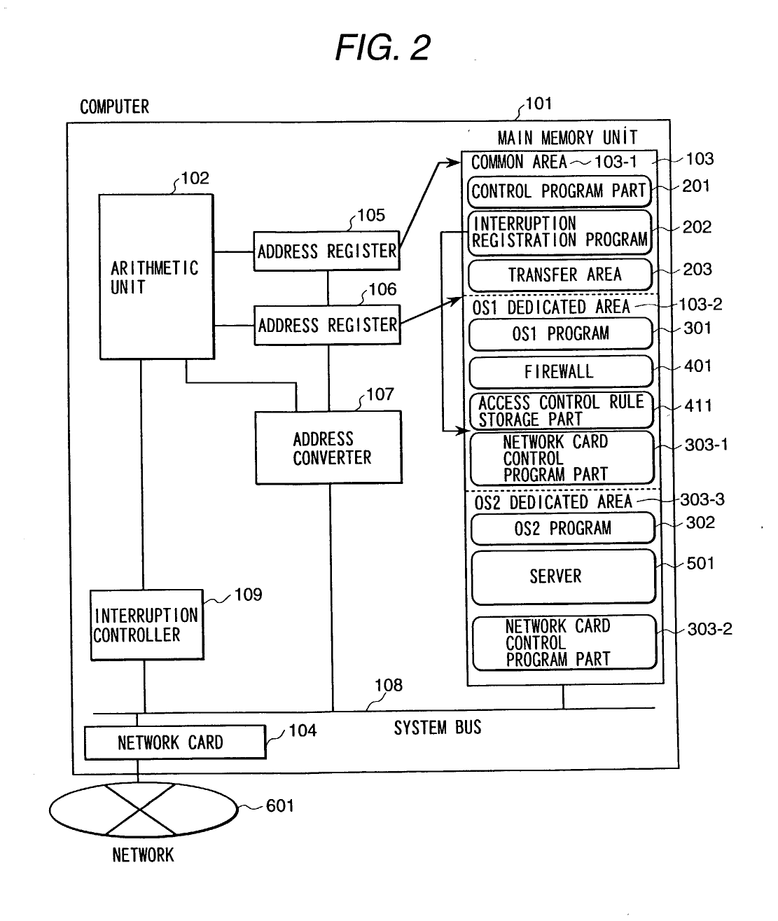

FIG. 2 illustrates an example of the configuration of the computer hardware 101. In FIG. 2, the interruption controller 109, the main memory unit 103, the address converter 107 and the network card 104 are connected to the system bus 108. The system bus 108 is connected to the peripheral devices such as mouse and keyboard, which are now shown.

The interruption controller 109, the address converter 107 and a couple of address registers 105 and 106 for specifying the address of the main memory unit 103 are connected to the arithmetic unit 102. The address register 105 specifies the address of the common area (memory area) 103-1 of the main memory unit 103, and the address register 106 specifies the head address of the operating system in-execution. The switching of OS1 301 and OS2 302 is performed by altering the value in the address register 106.

The common area 103-1 has the control program part 201, the interruption registration table 202 and the transfer area 203. The memory area 103-2 for OS1 301 has the program 301 of OS1 as well as the firewall 401, the rule storage part 411 for storing the access control rules and the network card control program part 303-1 for OS1.

Similarly, the memory area 103-3 for OS2 has the program 302 for OS2, the server 501 and the network card control program part 303-2 for OS. The network control program part 303-1 for OS1 is registered in the interruption registration table 202.

FIG. 3 illustrates an example of the configuration of the firewall 401. In FIG. 3, the firewall 401 comprises the input processing part 402, the output processing part 403, the access control processing part 404, the access control rule storage part 411 and the access control rule input part 405.

The input processing part 402 is normally in the state for waiting the input of the access data. The input processing part, receiving the interruption notification of receiving the access data, initiates its processing and then acquires the access data from the thick-lined path 702 shown in FIG. 1.

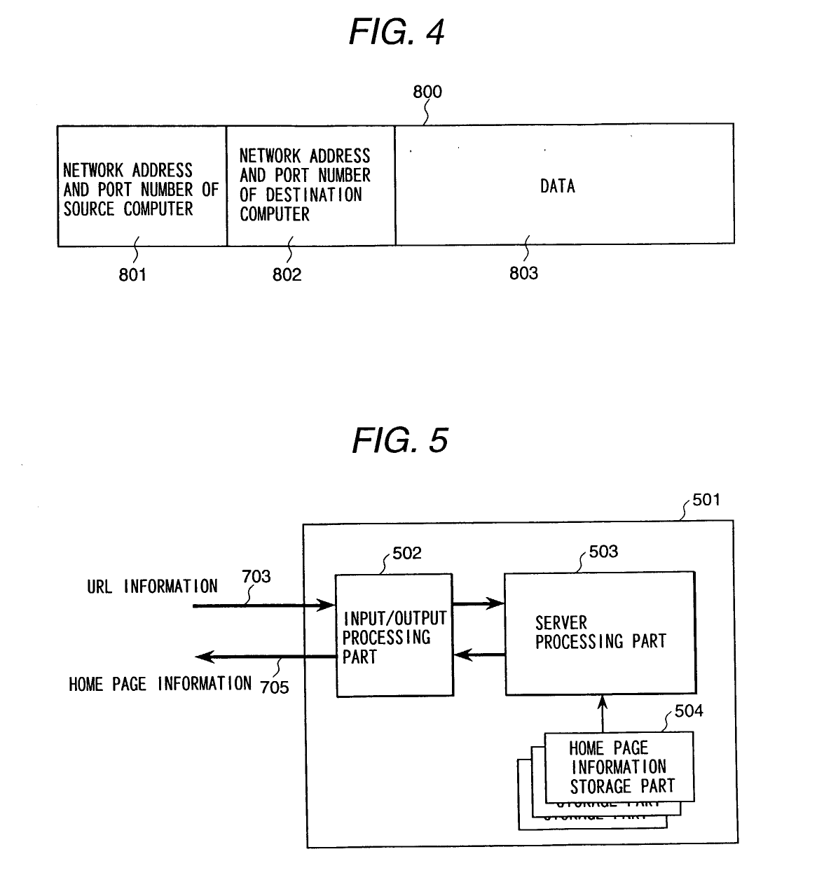

An example of the data format of the access data is shown in FIG. 4. The data format 800 comprises the network addresses and port numbers 801 and 802 of the destination computer and the source computer, and the transmission data 803. The network address is the address on the network defined for the individual computer. The port number is a unique identification for the port receiving plural kinds of data in a single computer.

In case that different kinds of application servers are executed in a single computer, the individual application servers are so configured by communicating data with distinctive port numbers as not to interfere with one another.

Now referring again to FIG. 3, the access data supplied to the input processing part 402 is provided to the access control processing part 404. The access control processing part 404 compares the received data (access data) contents with the transfer enable data or the transfer disable data defined in the access control rule storage part 411 in order to judge whether the transfer of the received data may be enabled or disabled.

In case that the access control processing part 404 concludes the data transfer disabled, it rejects the access data. Contrarily, in case of data transfer enabled, the access data is provided to the output processing part 403, and the access data is transmitted through the path 703 from the output processing part 403 to the server 501 as the data destination (Step 702). In the embodiment shown by FIG. 1, the transferred data is buffered temporarily into the transfer area 203 of the control program part 201, and then finally transferred to the server.

The firewall 401 has the access control rule input part 405. In case of modifying the access control rules stored in the access control rule storage part 411, the access control rule input part 405 receives the access control rule to be modified from the write dedicated server 508 to be described in FIG. 9, and modifies the content of the access control rule storage part 411. When the access control rule input part 405 modifies the rules stored in the access control storage part 411, the excusive control is activated in order to prevent the access control processing part 404 from referring to the access control rules.

FIG. 4 shows a configuration of Web server as an example of the server. In FIG. 4, the server 501 comprises the input and output processing part 502, the server processing part 503 and the Home Page information storage part 504.

The server 501 receives the information for identifying the home page information in terms of URL information (access data) at the input and output processing part 502 on the path 703, and then transfers the received information to the server processing part 503.

The server processing part 503 selects the Home Page information storage part 504 corresponding to the URL information and acquires the Home Page information, and then transmits the Home Page information through the input and output processing part 502 from the path 705. The Home Page information is transferred to the network 601 through the firewall 401, OS1 301 control program part 201 and the network card 104. The Home Page information is transferred to the network 601 in the flow backward to the thick-lined path shown in FIG. 1.

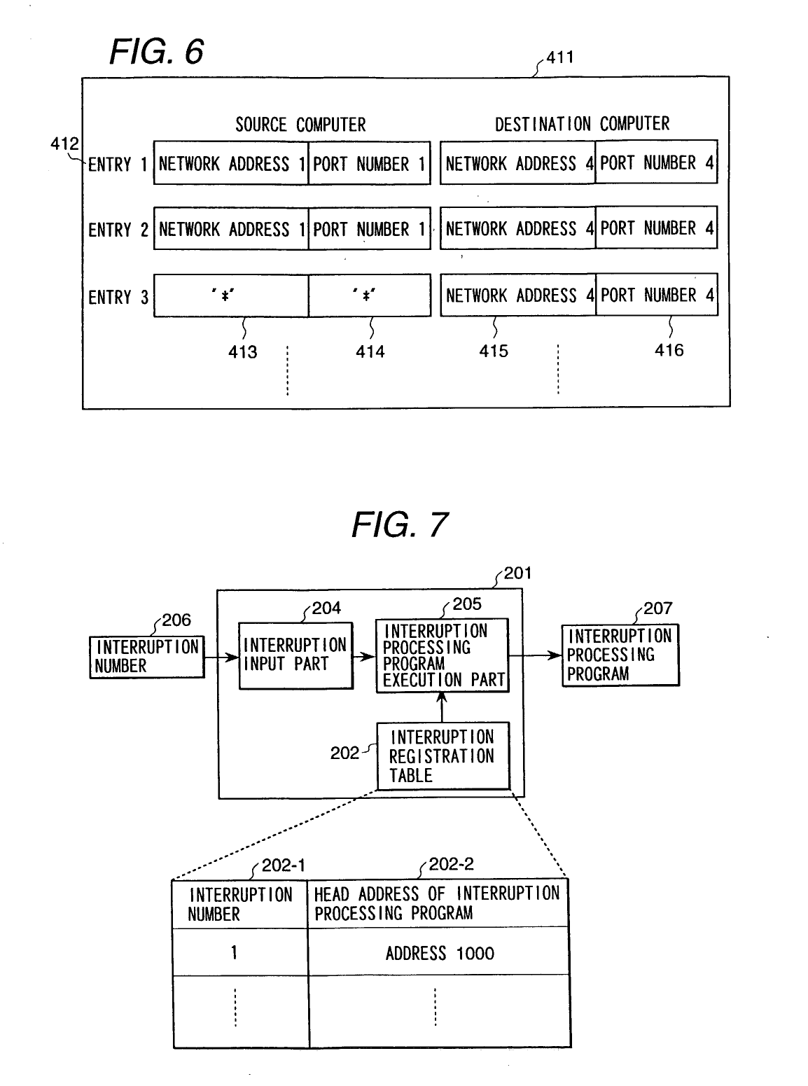

FIG. 6 shows an example of the access control rule stored in the access control rule storage part 411.

The access control rule describes the data containing the entry 412, the network addresses 413 and 415 of the source computer and the destination computer, and their port numbers 414 and 416.

The individual entry defines a single pattern of enabled or disabled data transfer. The number of entries corresponds to the number of rules. In FIG. 6, the definition of enabled data transfer is set as a rule corresponding to the individual entry, and in other words, the patterns not defined in the entries are defined implicitly to be disabled data transfer. For example, the entry 1 defines that the access data transmitted from the data port 1 of the computer having the network address 1 is enabled to be transferred to the data port 4 of the computer having the network address 4.

Specified character strings may be used for the network address 413 and the port number 414 in order to define multiple numbers. For example, the character “*” in the entry 3 represents any network address or port number allowed to be defined. For example, the entry 3 defines that the access data transmitted from the arbitrary port number 414 of the computer having the network address 413 is enabled to be transferred to the data port 4 of the computer having the network address 4.

FIG. 7 shows an example of the functional block diagram of the control program part 201. The control program part 201 comprises the interruption input part 204, the interruption processing program execution part 205 and the interruption registration table 202.

The interruption input part 204 accepts the interruption signal from the hardware such as the network card 104 and receives the interruption numbers 206 as input data in order to identify the interruption signal. The interruption numbers 206 are defined in advance for the individual peripheral devices such as network and monitor connected to the system bus shown 108 shown in FIG. 2.

The interruption registration table 202 is a table for mapping the interruption number 202-1 and the head address 202-2 of the interruption processing program, and for example, defines that the interruption processing program to be activated when the interruption having the interruption number 1 occurs is stored in the address at 1000.

The interruption processing program execution part 205 locates the entry corresponding to the interruption number 206 provided eventually in the interruption registration table 202, and then initiates the corresponding interruption processing program at its head address 202-2. In case that the interruption number 1 is provided, the program counter is made jumped to the address 1000 and then the interruption processing program 207 is initiated. The interruption processing program 207 is executed by the network card control program part 303-1.

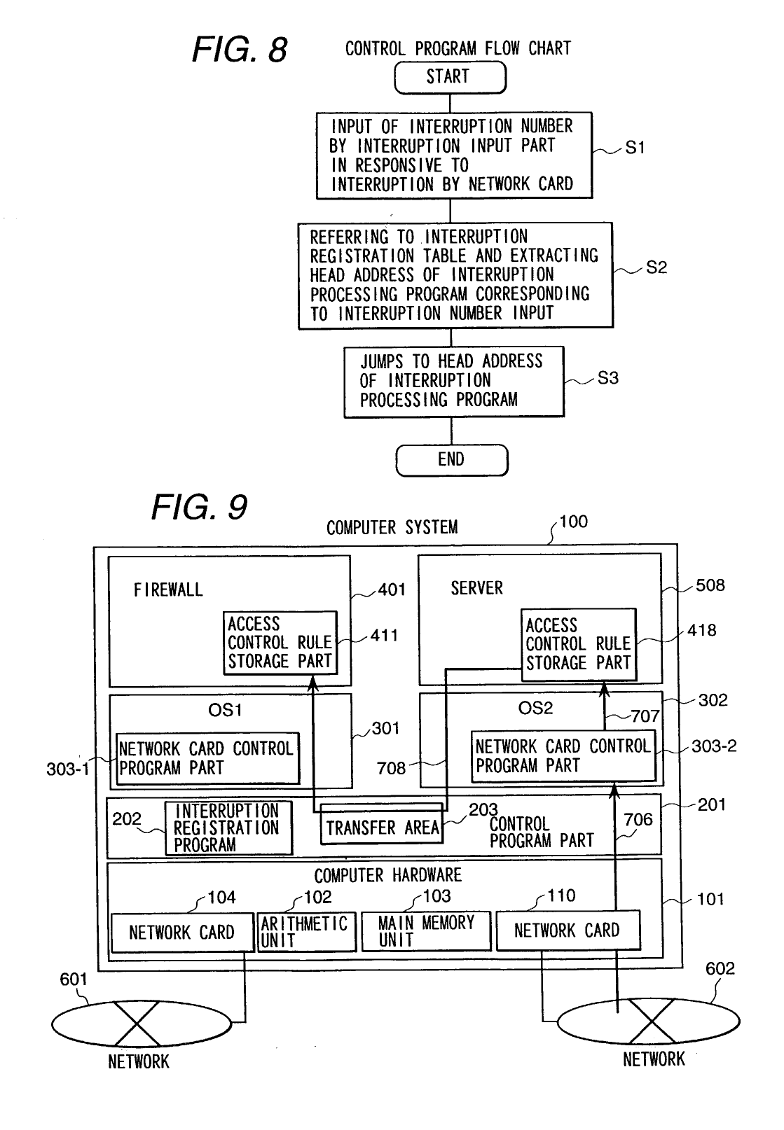

FIG. 8 shows a flowchart of the control program part 201 shown in FIG. 7. The control program 201 accepts the interruption from the network card 104 at its interruption input part 204, and inputs the interruption number (Step S1). With this operation, which hardware interrupts into the process can be identified

Going forward to Step S2, the interruption processing program execution part 205 refers to the interruption registration table 202 and searches the entry for the interruption processing program corresponding to the provided interruption number in order to determine which interruption processing program should be executed and then identifies its head address. In Step S3, the interruption processing program execution part 205 locates the program counter to the head address of the interruption processing program corresponding to the provided interruption number, and the network card control program part 303-1 is eventually executed.

In the embodiment shown in FIG. 1, as the network card control program part 303-1 for OS1 301 is registered as the program for processing the interruption from the network card 104, the access data from the network 601 is definitely received by OS1 and thus, the erroneous data transfer to OS2 can be prevented absolutely.

In other words, the access data supplied by the network 601 is definitely received by the firewall 401 executed on OS1 301, and thus, the access data from the network 601 does not reach the server 501 executed on OS2 without passing through the firewall 401 accidentally.

In the manner as described above, the access data provide from the network is received and processed. As the operating systems are installed independently on the firewall and the server and the access data is judged by the firewall and then transferred to the server, it will be appreciated that the functions for the firewall and the server can be established in a single computer without sacrificing the security level of the firewall.

FIG. 9 shows another embodiment of the present invention. In the embodiment shown in FIG. 9, the access control rule in the firewall 401 is modified by the server executed on OS2 302.

The difference in FIG. 9 from the embodiment shown in FIG. 1 is that the network card 110 connected to the network 602 is installed in the computer hardware 101 and the access control rule storage part 418 is installed in the server dedicated for writing rules. The network 602 is exclusively used for modifying the access control rules and is connected to the computers such as center systems. The server 501 shown in FIG. 1 is not shown in FIG. 9 for simplification of explanation.

In the embodiment shown in FIG. 9, the interruption registration table 202 maps the network control program part 303-1 of OS1 301 onto the network card 104 connected to the network 601, and the network control program part 303-2 of OS2 302 onto the network card 110 connected to the network 602 for inputting the access control rule information.

In case of modifying the access control rules, the access control rule information supplied from the network 602 is input as interruption to the network control program part 303-2 of OS2 302. The network control program part 303-2 of OS2 302 transfers the access control rule for modification through the path 707 to the serer 508 and then stores this information temporarily at the access control rule storage part 418.

The server 508, receiving the access control rule for modification, verifies its rationality and updates the access control rule storage part 411 of the firewall 401 via the transfer area 203 of the control program part 201.

In the embodiment shown in FIG. 9, it is also appreciated that the firewall and the server can be executed in a single computer without sacrificing the security level of the firewall, and that the access control rule can be updated with a secured path established independently of the path used for the ordinary data communication.

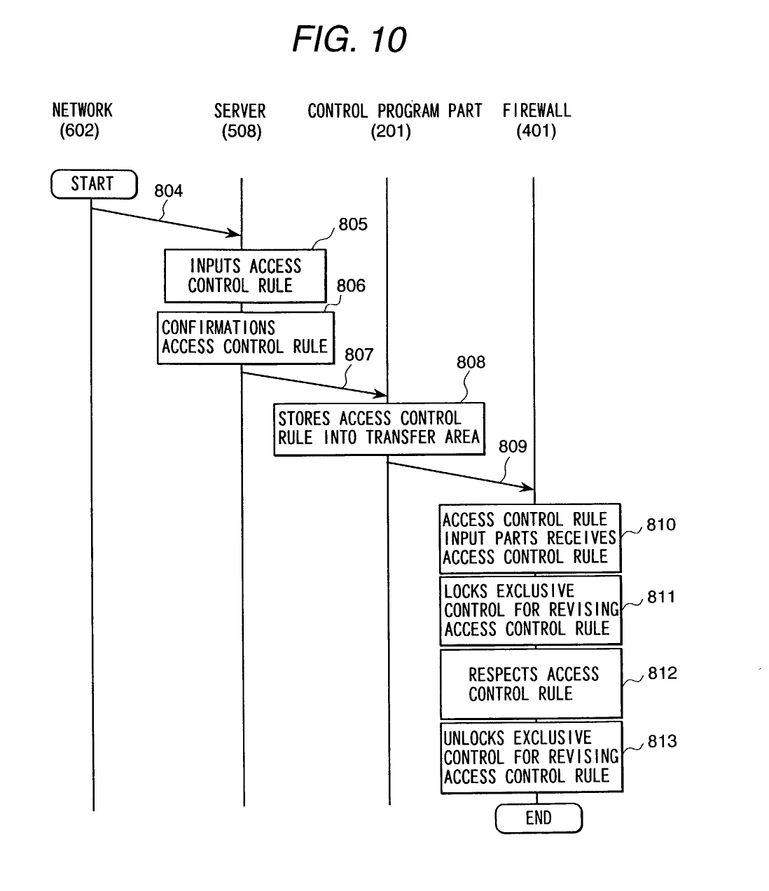

FIG. 10 shows a procedural sequence for modifying the access control rule by the server 508.

The network 602 is installed exclusively or modifying the access control rules, and the server 508 receives the updated access control rule through the network 602 (Step 805). The server 508, receiving the updated access control rule, verifies its rationality (Step 806) and then stores the access control rule in the transfer area 203 of the control program part 201 (Step 808).

The access control rule input part 405 of the firewall 401 shown in FIG. 3, receiving the updated access control rule (Step 810), initiates the exclusive control for updating the access control rule (Step 811). Owing to this procedure, the reference of the access control rule by the access control processing part 404 is made prohibited in order to prevent the access control rule under update processing from being referred accidentally for judging whether the data transfer is enabled or disabled. The data reference to the access control rule is hold in wait state until the exclusive control is established.

When the exclusive control is established, the updated access control rule is written in the firewall (Step 812). Subsequently, the exclusive control is made released (Step 813), and then the update operation is completed. Thus, it will be appreciated that the rule can be updated by the secured path for updating the access control rule independently from the ordinary access path to the server.

In the manner as described above, the access data provide from the network is received and processed. As the operating systems are installed independently on the firewall and the server and the access data is judged by the firewall and then transferred to the server, it will be appreciated that the functions for the firewall and the server can be established in a single computer without sacrificing the security level of the firewall.

As the access control rule is updated by using the secured communication path independently from the ordinary path for data communication, it will be appreciated that the system reliability can be increased.

Though a single computer executes a single firewall in the above embodiments, it is obviously allowed for the single computer to executes two or more firewalls.

It is obvious that the data communication between the firewall and the server may be conducted directly without using the control program.

According to the present invention, as the individual operating systems are installed independently in the firewall and the serer and the access data is judged by the firewall and transferred to the server, it will be appreciated that the firewall and the server can be executed on a single computer without sacrificing the security level of the firewall.

In addition, as the access control rule is updated by using the secured communication path independently from the ordinary path for data communication, it will be appreciated that the system reliability can be increased.

What is claimed is:

1. A firewall computer system, wherein
at least a first operating system and a second operating system are installed in a single computer, and said first operation system and said second operating system are so configured as to be switchable;
a firewall is executed on said first operating system;
a server is executed on said second operating system; and
an access control rule is provided in said firewall, wherein
an access data from a network to said server is judged by said firewall according to said access control rule in order to determine whether its data transfer is enabled or disabled, and an access data with its data transfer judged to be enabled is transferred to said server.

2. A firewall computer system, wherein
at least a first operating system and a second operating system are installed in a single computer, and said first operation system and said second operating system are so configured as to be switchable;
a firewall is executed on said first operating system;
a server is executed on said second operating system; and
an access control rule is provided in said firewall, wherein
an access data from a network to said server is handled as an interruption exclusively only by said firewall and said firewall, according to said access control rule, judges whether its data transfer-is enabled or disabled, and an access data with its data transfer judged to be enabled is transferred to said server.

3. A firewall computer system, wherein
at least a first operating system and a second operating system are installed in a single computer, and said first operation system and said second operating system are so configured as to be switchable;
a firewall is executed on said first operating system;
a server is executed on said second operating system; and
an access control rule is provided in said firewall, wherein
an access data from a network sets up an interruption to said firewall, and
an access data from said network to said server is handled as an interruption exclusively only by said firewall and said firewall, according to said access control rule, judges whether its data transfer is enabled or disabled, and an access data with its data transfer judged to be enabled is transferred to said server.

4. A firewall computer system wherein at least a first operating system and a second operating system are installed in a single computer, and said first operation system and said second operating system are so configured as to be switchable, comprising
a firewall means executed on said first operating system and defined with an access control rule;
a server executed on said second operating system;
a network card receiving an access data from a network; and
a control program means controlling said firewall means so as to process said access data from said network, wherein
said firewall judges whether its data transfer for an access data to be transferred from said network to said server is enabled or disabled in response to said access control rule; and
an access data with its data transfer judged to be enabled is transferred to said server.

5. A multi-operating system based firewall computer system wherein at least a first operating system and a second operating system are installed in a single computer, and said first operation system and said second operating system are so configured as to be switchable, comprising
a firewall means executed on said first operating system and defined with an access control rule;
a server executed on said second operating system;
a network card receiving an access data from a network; and
a control program means for notifying an interruption from said network to said firewall means, wherein
said firewall judges whether its data transfer for an access data to be transferred from said network to said server is enabled or disabled in response to said access control rule; and
an access data with its data transfer judged to be enabled is transferred to said server.

6. A multi-operating system based firewall computer system wherein at least a first operating system and a second operating system are installed in a single computer, and said first operation system and said second operating system are so configured as to be switchable, comprising
a firewall means executed on said first operating system and defined with an access control rule;
a server executed on said second operating system;
a network card receiving an access data from a network; and
a control program means for notifying an interruption from said network to said firewall means, wherein
said firewall judges whether its data transfer for an access data to be transferred from said network to said server is enabled or disabled in response to said access control rule; and
an access data with its data transfer judged to be enabled is transferred to said server through a transfer area of said control program means.

7. A firewall computer system, wherein
at least a first operating system and a second operating system are installed in a single computer, and said first operation system and said second operating system are so configured as to be switchable;
a firewall is executed on said first operating system;
a server is executed on said second operating system; and
an access control rule is provided in said firewall, wherein
an access data from a first network is handled exclusively only by said firewall;
a updating access control rule provided from a second network is received by a second server and then an access control rule for said firewall is modified;
said firewall judges whether its data transfer for an access data to be transferred from said network to said server is enabled or disabled in response to said access control rule; and
an access data with its data transfer judged to be enabled is transferred to said server.

8. A multi-operating system based firewall computer system wherein at least a first operating system and a second operating system are installed in a single computer, and said first operation system and said second operating system are so configured as to be switchable, comprising
a firewall means executed on said first operating system and defined with an access control rule;
a first server executed on said second operating system;
a first network card receiving an access data from a first network;
a second network card receiving an access data from a second network;
a second server receiving said updating access control rule and modifying an access control rule for said firewall; and
a control program means for notifying an interruption from said first network to said firewall means and notifying an interruption from said second network to said server, wherein
said firewall judges whether its data transfer for an access data to be transferred from said first network to said first server is enabled or disabled in response to said access control rule; and
an access data with its data transfer judged to be enabled is transferred to said first server.
